(19) United States
(12) Patent Application Publication
(10) Pub. No.: US 2019/0062507 A1
(43) Pub. Date: Feb. 28, 2019

(54) ORGANOPOLYSILOXANE AND PRODUCTION METHOD THEREFOR, AND CURABLE COMPOSITION

(71) Applicant: SHIN-ETSU CHEMICAL CO., LTD., Tokyo (JP)

(72) Inventor: Osamu TSUCHIDA, Annaka-shi (JP)

(73) Assignee: SHIN-ETSU CHEMICAL CO., LTD., Tokyo (JP)

(21) Appl. No.: 16/079,765

(22) PCT Filed: Jan. 31, 2017
(86) PCT No.: PCT/JP2017/003405

§ 371 Date: Aug. 24, 2018

(30) Foreign Application Priority Data
Feb. 25, 2016 (JP) 2016-034504
Feb. 25, 2016 (JP) 2016-034535

(51) Int. Cl. C08G 77/388; C08G 77/08; C07F 7/08

(52) U.S. Cl. CPC C08G 77/388; C08G 77/08; C08G 77/70; C07F 7/0889; C07F 7/0838

(57) ABSTRACT

Provided are: a novel imide-modified organopolysiloxane in a liquid form having excellent resistance to heat; a method for producing the organopolysiloxane; and a curable composition that contains the organopolysiloxane and that can be cured by irradiation with light without using an initiator.

The organopolysiloxane is represented by formula (1).

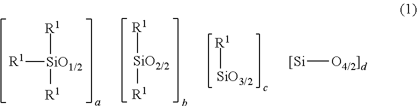

(Wherein: each R¹ represents an unsubstituted or substituted monovalent hydrocarbon group having 1-10 carbon atoms or an organic group having a structure represented by formula (2) or (3), and at least one of the R¹s is the organic group having a structure represented by formula (2) or (3); a represents an integer of 2 or more; b, c, and d each represent an integer of 0 or more; and 2≤a+b+c+d≤1,000 is satisfied.)

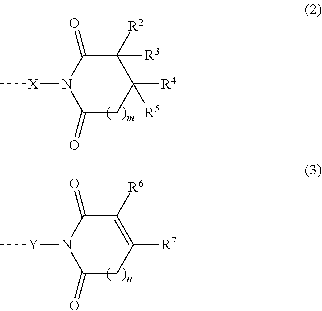

(Wherein: R²-R⁷ each represent a hydrogen atom or an unsubstituted or substituted monovalent hydrocarbon group having 1-10 carbon atoms; R² or R³ may be linked with R⁴ or R⁵ to form a ring, and R⁶ may be linked with R⁷ to form a ring; m and n each represent an integer of 0-3; and X and Y each represent an unsubstituted or substituted divalent hydrocarbon group that has 1-10 carbon atoms and that optionally contains an intervening heteroatom. A dashed line represents a bond.)

### TECHNICAL FIELD

The present invention relates to a novel organopolysiloxane, particularly an organopolysiloxane having excellent heat resistance, and to a method for preparing the same. The invention further relates to a curable composition that uses this novel organopolysiloxane, especially a curable composition which, on account of the presence of photoreactive functional groups, can be advantageously used in UV-curable materials and the like.

### BACKGROUND ART

Organopolysiloxanes are organic-inorganic composite polymers which have siloxane bonds on the main chain and organic groups on the side chains. These materials have excellent characteristics such as heat resistance, weatherability, slideability, chemical resistance and electrically insulating properties, and exist in the form, for example, oils, rubbers and resins. Organopolysiloxane oils, which are also called silicone oils, have a higher heat resistance and weatherability than other organic oils, in addition to which another characteristic is their distinctively smooth, dry feel to the touch. Because of their excellent heat resistance, they are used as, for example, industrial heat transfer media.

A variety of organic groups are used in silicone oils. Examples of non-reactive organic groups include alkyl groups, phenyl groups, polyether groups, fluoroalkyl groups and perfluoropolyether groups. Examples of reactive organic groups include vinyl groups, epoxy groups, amino groups, hydroxyl groups, mercapto groups and carboxyl groups. Each type of silicone oil is used selectively according to the intended application.

Also, imide is the generic term for compounds of the general formula R^{a}—CO—NR^{b}—CO—R^{c} (wherein R^{a}, R^{b} and R^{c} represent organic groups) containing nitrogen and having two C═O linkages that are obtained by reacting a primary amine with a carboxylic acid anhydride. This structure is chemically important and is used in all fields of industry, including pharmaceutical and pesticide intermediates, paints and organic resins. Commonly known imides include polyimide resins, which are polymers having consecutive imide structures. These have excellent properties, such as heat resistance, electrical insulating properties, chemical resistance and mechanical strength, and are to known as one type of super-engineering plastic. With regard to heat resistance in particular, these materials exhibit the highest level of heat resistance of all resins.

By combining an imide with an organopolysiloxane, it is possible to produce an excellent material that possesses the features of each. For example, Patent Publications 1 to 4 (JP No, 4218282, JP-A 2004-263058, JP No. 5314856 and JP No. 4204435) describe siloxane-polyimide copolymers obtained using a diaminopolysiloxane as a starting material and show these to be industrially important materials having various features. However, because recurring imide structures are present, the product is a solid. Hence, a drawback is that, depending on the application, handling is difficult.

Composite materials of imides and organopolysiloxanes are not solvent dilutable and substantially none are liquid, the reason being that rigid imide structures are present on the polymer backbone. It is thought that by synthesizing an imide-modified organopolysiloxane in which the backbone consists solely of organopolysiloxane which is modified on side chains with organic groups having an imide structure, a liquid material having the features of both materials can be obtained. However, such a material does not yet exist.

Resins obtained by curing liquid resin compositions are widely utilized in a variety of fields. Curing proceeds via the formation of a crosslinked structure due to chemical bonds within the composition. The energy sources for such formation include heat and light.

There are a variety of types of thermoset resins, including urea resins, melamine resins, epoxy resins, phenolic resins, urethane resins and unsaturated polyester resins. The ingredients for these contain functional groups that form chemical bonds under the effect of heat, and thus cure under heating.

Photocurable resins are resins having functional groups that form a crosslinked structure under the effect of light. Typical functional groups include (meth)acrylic groups, mercapto groups and epoxy groups. (Meth)acrylic groups form crosslinks by to radical-mediated polymerization reactions, and mercapto groups give rise to a radical-mediated ene-thiol reaction in the presence of alkenyl groups. Epoxy groups undergo cationic polymerization under the effect of an acid generated by light.

Photocurable resins are used in all areas of industry and have the advantage that they can be utilized even in environments where applying heat would pose a problem. Silicones are one type of resin having such photoreactive functional groups. Silicone is the generic term for organopolysiloxanes in which the backbone is made up of consecutive siloxane linkages and which has organic groups such as methyl groups on the side chains.

Photocurable silicones are starting materials for cured products such as silicone rubbers, silicones for release paper, and hardcoat-forming silicones. Silicones having the above-mentioned (meth)acrylic groups, mercapto groups and epoxy groups are widely known (e.g., JP-A H07-26146, JP-B H06-49764, JP-B H06-17447: Patent Documents 5 to 7), and have hitherto been put to practical use. These require the admixture of a radical polymerization initiator or a photoacid generator prior to light irradiation.

One photoreactive functional group that has attracted attention lately is the maleimide group. The maleimide group is a functional group having a carbon-carbon double bond conjugated with the two carbonyl groups of the imide. It has radical polymerizability, along with which it has the singular attribute that the double bond site dimerizes under the effect of light. Owing to the two mechanisms of radical polymerization and photodimerization, the reaction proceeds upon irradiation with light, even without the use of an initiator. By making use of this, it is possible, with a silicone having maleimide groups, to achieve a new one-part resin that requires no initiator. However, this remains substantially uninvestigated to date.

### PRIOR ART DOCUMENTS

### Patent Documents

Patent Document 1: JP 4218282

Patent Document 2: JP-A 2004-263058

Patent Document 3: JP 5314856

Patent Document 4: JP 4204435

Patent Document 5: JP-A H07-26146

Patent Document 6: JP-B H06-49764

Patent Document 7: JP-B H06-17447

### SUMMARY OF INVENTION

### Technical Problem

It is therefore an object of the present invention to provide a novel imide-modified organopolysiloxane in liquid form that has excellent heat resistance. Another object is to provide a method for preparing such an organopolysiloxane. A further object is to provide a curable composition which includes this novel imide-modified organopolysiloxane and can be cured without the use of an initiator by irradiation with light.

### Solution to Problem

The inventors have conducted extensive investigations in order to achieve the above objects. As a result, they have discovered that by reacting the subsequently described amino group-containing organic group-containing organopolysiloxane of formula (4) with an organic compound of formula (5) or (6) and subsequently reacting the product thereof with a silylating agent in the presence of a Lewis acid catalyst, a novel imide-modified organopolysiloxane of formula (1) can be obtained, which organopolysiloxane is in liquid form and has an excellent heat resistance.

The inventors have also discovered that by photoirradiating a curable composition containing this novel imide-modified organopolysiloxane, a cured product can be formed without the use of an initiator.

Accordingly, this invention provides the following organopolysiloxane, method of preparation thereof and curable composition.
[1] An organopolysiloxane which has average compositional formula (1) below and to includes at least one organic group with a structure of general formula (2) or (3) below per molecule

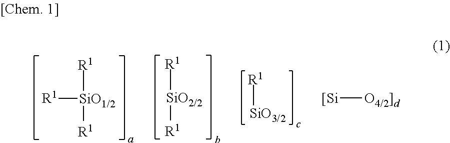

(wherein the R¹ moieties, which may be the same or different, are substituted or unsubstituted monovalent hydrocarbon groups of 1 to 10 carbon atoms or organic groups having a structure of general formula (2) or (3) below, at least one R¹ moiety including an organic group having a structure of general formula (2) or (3) below; and the subscript a is an integer of 2 or more, the subscript b is an integer of 0 or more, the subscript c is an integer of 0 or more, the subscript d is an integer of 0 or more, and 2≤a+b+c+d≤1,000)

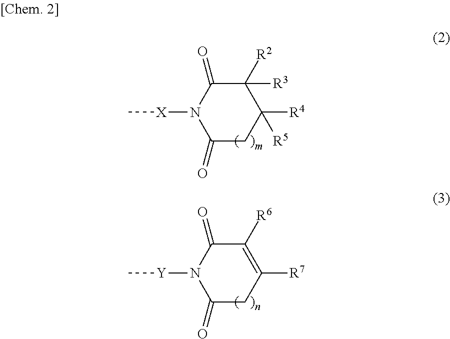

(wherein R² to R⁷, which may he mutually the same or different, are hydrogen atoms or substituted or unsubstituted monovalent hydrocarbon groups of 1 to 10 carbon atoms, and R² or R³ and R⁴ or R⁵, or R⁶ and R⁷, may bond together to form a ring; the subscripts m and n are integers from 0 to 3; X and Y are substituted or unsubstituted divalent hydrocarbon groups of 1 to 10 carbon atoms which may have an intervening heteroatom; and the dashed line represents a site available for bonding).
[2] The organopolysiloxane of [1] above wherein, in formula (1), the subscript a is an integer from 2 to 12, the subscript b is an integer from 5 to 500, the subscript c is an integer from 0 to 10, the subscript d is an integer from 0 to 5. and the sum a+b+c+d is from 7 to 527.
[3] A method for preparing the organopolysiloxane having formula (1) of [1] above using:

(A) 100 parts by weight of an organopolysiloxane which has average compositional to formula (4) below and includes at least one amino group-containing organic group of 1 to 10 carbon atoms per molecule

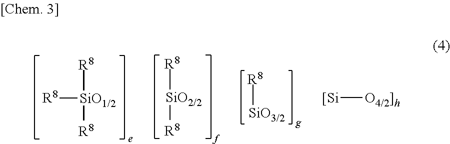

(wherein the R⁸ moieties, which may be the same or different, are substituted or unsubstituted monovalent hydrocarbon groups of 1 to 10 carbon atoms or amino group-containing organic groups of 1 to 10 carbon atoms, at least one R⁸ moiety including an amino group-containing organic group of 1 to 10 carbon atoms; and the subscript e is an integer of 2 or more, the subscript f is an integer of 0 or more, the subscript g is an integer of 0 or more, the subscript h is an integer of 0 or more, and 2≤e+f+g+h≤1,000),

(B) an organic compound of general formula (5) or (6) below in an amount corresponding to a molar ratio of from 1 to 3 with respect to the amino groups in component (A)

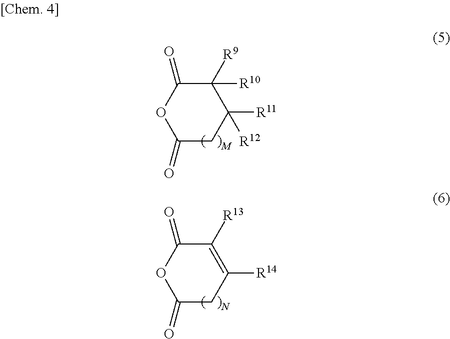

(wherein R⁹ to R¹⁴, which may be mutually the same or different, are hydrogen atoms or substituted or unsubstituted monovalent hydrocarbon groups of 1 to 10 carbon atoms, and R⁹ or R¹⁰ and R¹¹ or R¹², or R¹³ and R¹⁴, may bond together to form a ring; and M and N are integers from 0 to 3),

(C) a Lewis acid catalyst in an amount corresponding to a molar ratio of from 0.1 to 2 with respect to the amino groups in component (A),

(D) a silylating agent in an amount corresponding to a molar ratio of from 1 to 3 with respect to the amino groups in component (A), and

(E) an organic solvent in an amount of from 0 to 5,000 parts by weight per 100 parts to by weight of component (A),

which method comprises the steps of:

reacting component (A) with component (B) in the presence of, optionally, component (E) to form an organopolysiloxane (F) of average compositional formula (7) below

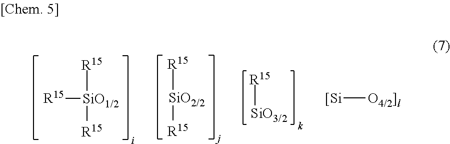

(wherein the R¹⁵ moieties, which may be the same or different, are substituted or unsubstituted monovalent hydrocarbon groups of 1 to 10 carbon atoms or organic groups having a structure of general formula (8) or (9) below, at least one R¹⁵ moiety including an organic group having a structure of general formula (8) or (9) below; and the subscript i is an integer of 2 or more, the subscript j is an integer of 0 or more, the subscript k is an integer of 0 or more, the subscript l is an integer of 0 or more, and 2≤i+j+k+1≤1,000)

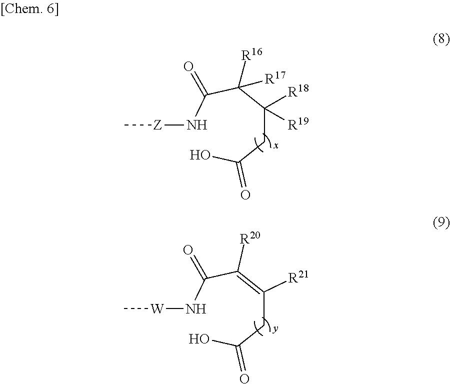

(wherein R¹⁶ to R²¹, which may be mutually the same or different, are hydrogen atoms or substituted or unsubstituted monovalent hydrocarbon groups of 1 to 10 carbon atoms, and R¹⁶ or R¹⁷ and R¹⁸ or R¹⁹, or R²⁰ and R²¹, may bond together to form a. ring; the subscripts x and y are integers from 0 to 3; Z and W are substituted or unsubstituted divalent hydrocarbon groups of 1 to 10 carbon atoms which may have an intervening heteroatom; and the dashed line represents a site available for bonding); and

subsequently mixing in components (C) and (D) and effecting a condensation reaction between amide groups and carboxyl groups in component (F).
[4] The organopolysiloxane preparation method of [3] above wherein, in formula (1), to the subscript a is an integer from 2 to 12, the subscript h is an integer from 5 to 500, the subscript c is an integer from 0 to 10, the subscript d is an integer from 0 to 5, and the sum a+b+c+d is from 7 to 527.
[5] The organopolysiloxane preparation method of [3] or [4] above, wherein component (A) has an amine equivalent weight of from 200 to 5,000 g/mol.
[6] The organopolysiloxane preparation method of any of [3] to [5] above, wherein component (B) is succinic anhydride, maleic anhydride, glutaric anhydride, adipic anhydride, pimelic anhydride or phthalic anhydride.
[7] The organopolysiloxane preparation method of any of [3] to [6] above, wherein component (C) is a metal compound.
[8] The organopolysiloxane preparation method of [7] above,wherein component (C) is a zinc compound.,
[9] The organopolysiloxane preparation method of any of [3] to [8] above, wherein component (D) is a disilazane compound.
[10] A curable composition which cures on exposure to radiation, comprising at least one organopolysiloxane of the average compositional formula. (1′) below and including at least one organic group with a structure of general formula (3′) below per molecule

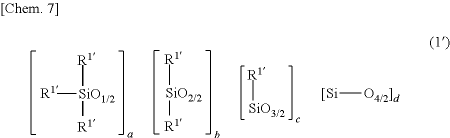

(wherein the R^{1′} moieties, which may be the same or different, are substituted or unsubstituted monovalent hydrocarbon groups of 1 to 10 carbon atoms or organic groups having a structure of general formula (3′) below, at least one R^{1′} moiety including an organic group having a structure of general formula (3′) below; and the subscript a is an integer of 2 or more, the subscript b is an integer of 0 or more, the subscript c is an integer of 0 or more, the subscript d is an integer of 0 or more, and 2≤a+b+c+D≤1,000)

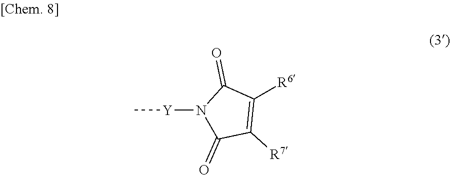

(wherein R⁶ and R^{7′}, which may be mutually the same or different, are hydrogen atoms or substituted or unsubstituted monovalent hydrocarbon groups of 1 to 5 carbon atoms; Y is as defined above; and the dashed line represents a site available for bonding).
[11] The curable composition of [10] above which comprises the organopolysiloxane of formula (1′) above.
[12] The curable composition of [10] or [11] above wherein, in formula (1′), the subscript a is an integer from 2 to 12, the subscript b is an integer from 5 to 500, the subscript c is an integer from 0 to 10, the subscript d is an integer from 0 to 5, and the sum a+b+c+d is from 7 to 527.
[13] The curable composition of any of [10] to [12] above, wherein R^{6′} and R^{7′} of formula (3′) are hydrogen atoms.
[14] The curable composition of any of [10] to [13] above which includes no photopolymerization initiator.

### ADVANTAGEOUS EFFECTS OF INVENTION

The novel organopolysiloxane of the invention is a liquid having an imide structure and can be used as a highly heat-resistant material. Also, the curable composition of the invention can be cured by photoirradiation, particularly exposure to radiation, without requiring an initiator, and can be used in, for example, coating materials and rubber materials.

### DESCRIPTION OF EMBODIMENTS

The invention is described in detail below.

### [Organopolysiloxane]

The organopolysiloxane of the invention is modified with organic groups that include an imide structure, and has average compositional formula (1) below

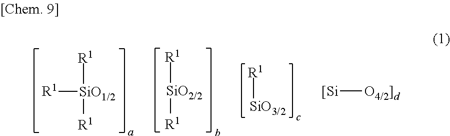

(wherein the R¹ moieties, which may be the same or different, are substituted or unsubstituted monovalent hydrocarbon groups of 1 to 10 carbon atoms or organic groups having a structure of general formula (2) or (3) below, at least one R¹ moiety including an organic group having a structure of general formula (2) or (3) below; and the subscript a is an integer of 2 or more, the subscript b is an integer of 0 or more, the subscript c is an integer of 0 or more, the subscript d is an integer of 0 or more, and 2≤a+b+c+d≤1,000)

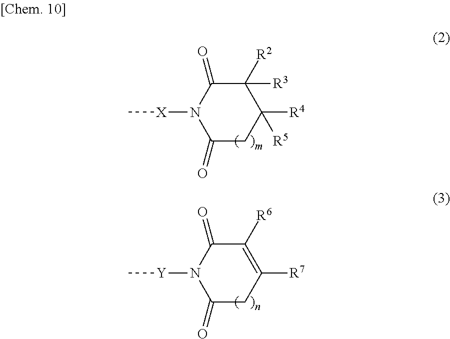

(wherein R² to R⁷, which may be mutually the same or different, are hydrogen atoms or substituted or unsubstituted monovalent hydrocarbon groups of 1 to 10 carbon atoms, and R² or R³ and. R⁴ or R⁵, or R⁶ and R⁷, may bond together to form a ring; the subscripts m and n are integers from 0 to 3; X and Y are substituted or unsubstituted divalent hydrocarbon groups of 1 to 10 carbon atoms which may have an intervening heteroatom; and the dashed line represents a site available for bonding).

In above formula (1), the R¹ moieties, which may be the same or different, include substituted or unsubstituted monovalent hydrocarbon groups of 1 to 10 carbon atoms or organic groups having a structure of above general formula (2) or (3), at least one R¹ moiety including an organic group having a structure of general formula (2) or (3) above. Examples of monovalent hydrocarbon groups include alkyl groups such as methyl, ethyl, propyl and butyl groups, cycloalkyl groups such as the cyclohexyl group, and aryl groups such as the phenyl group. In addition, some or all of the hydrogen atoms bonded to carbon atoms on these groups may be substituted with halogen atoms or other groups. Exemplary substituents are trifluoromethyl and 3,3,3-trifluoropropyl groups. Of these, a saturated aliphatic group or an aromatic group is preferred, with methyl and phenyl groups being more preferred.

In this invention, at least one, preferably from 2 to 200, and more preferably from 2 to 150, of the R′ moieties include an organic group having a structure of general formula (2) or (3).

In above formulas (2) and (3), R² to R⁷, which may be mutually the same or different, are hydrogen atoms or substituted or unsubstituted monovalent hydrocarbon groups of 1 to 10 carbon atoms. Exemplary monovalent hydrocarbon groups include alkyl groups such as methyl, ethyl, propyl and butyl groups, cycloalkyl groups such as the cyclohexyl group, and aryl groups such as the phenyl group. in addition, some or all of the hydrogen atoms bonded to carbon atoms on these groups may be substituted with halogen atoms or other groups. Exemplary substituents include trifluoromethyl and 3,3,3-trifuoropropyl groups. Hydrogen atoms and methyl groups are preferred. R² or R³ and R⁴ or R⁵, or R⁶ and R⁷, may bond together to form a ring. The ring is exemplified by a cyclopropane ring, a cyclohutane ring, a cyclopentane ring, a cyclohexane ring and a benzene ring. A benzene ring is preferred.

The subscripts m and n are each integers from 0 to 3, preferably integers from 0 to 2, and more preferably 0 or 1.

X and Y are each substituted or unsubstituted divalent hydrocarbon groups of 1 to 10 carbon atoms which may have an intervening heteroatom. Examples include alkylene groups such as CH₂, C₂H₄, C₃H₆, C₄H₈, C₅H₁₀ and C₆H₁₂ which may have an intervening ether group or thioether group. Alternatively, a cyclic structure such as a phenylene or cyclohexylene group may be formed. Some or all of the hydrogen atoms bonded to carbon atoms may be substituted with halogen atoms or other groups.

Exemplary structures of general formula (2) or (3) include, but are not limited to, to those shown below.

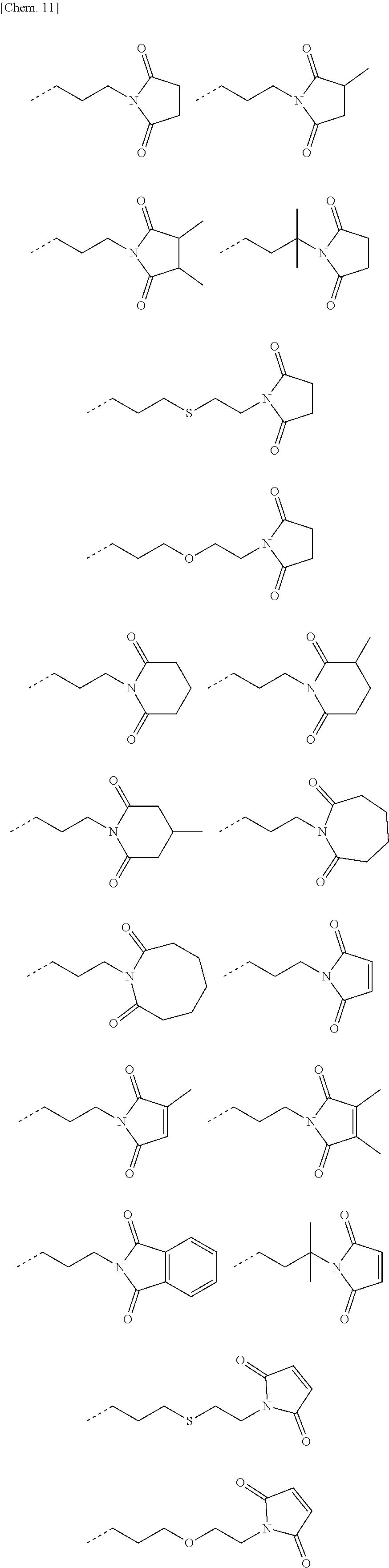

In these formulas, the dashed line indicates a site available for bonding.

In above formula (1), the subscript a is an integer of 2 or more, preferably from 2 to 12; the subscript b is an integer of 0 or more, preferably from 1 to 998, more preferably from 5 to 998, and even more preferably from 5 to 500; the subscript c is an integer of 0 or more, and preferably from 0 to 10; the integer d is an integer of 0 or more, and preferably from 0 to 5; and 2≤a+b+c+d≤1,000, preferably 7≤a+b+c+d≤527. When the sum a+b+c+d is larger than 1,000, the viscosity may be high and the workability may worsen.

Exemplary structures of the organopolysiloxane represented by formula (I) include, to but are not limited to, those of the formulas shown below. In the following formulas, “Me” and “Ph” stand for, respectively, a methyl group and a phenyl group, and “I” stands for an N-succinimidopropyl group or an N-maleimidopropyl group. Any organic group having a structure of formula (2) or (3) is acceptable.

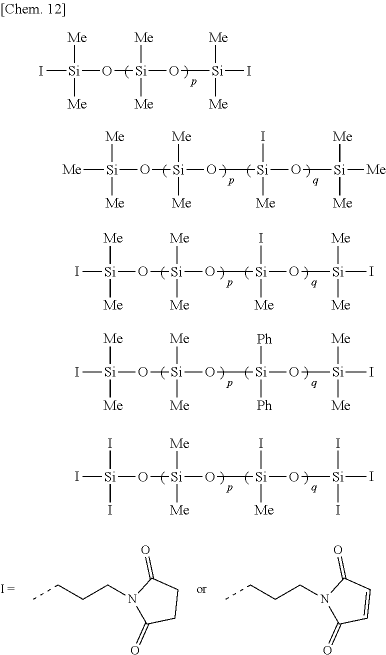

Here, p≥0, q≥1, and a dashed line indicates a site available for bonding.

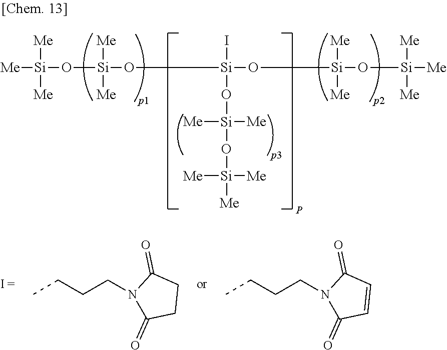

Here, p1>0, p2≥0. p3≥0, P≥1, and a dashed line indicates a site available for bonding.

### [Method of Preparing Organopolysiloxane]

The organopolysiloxane of the invention can be obtained by addition reacting (A) an organopolysiloxane of average compositional formula (4) below and having at least one amino group-containing organic group on the molecule with (B) an organic compound of general formula (5) or (6) below in the optional presence of (E) an organic solvent, and additionally mixing in (C) a Lewis acid catalyst and (D) a silylating agent and effecting a condensation reaction (imidization reaction),

Details on the ingredients serving as the starting materials for the organopolysiloxane of the invention and on the method of preparation are given below.

### [Component (A)]

Component (A) is an organopolysiloxane which has the following average compositional formula (4) and includes at least one amino group-containing organic group per molecule

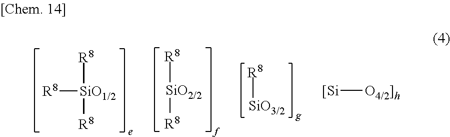

(wherein the R⁸ moieties, which may be the same or different, are substituted or unsubstituted monovalent hydrocarbon groups of 1 to 10 carbon atoms or amino group-containing organic groups of 1 to 10 carbon atoms, at least one R⁸ moiety including an amino group-containing organic group of 1 to 10 carbon atoms; and the subscript e is an integer of 2 or more, the subscript f is an integer of 0 or more, the subscript g is an integer of 0 or more, the subscript h is an integer of 0 or more, and 2≤e+f+g+h≤1,000).

In formula (4), the R⁸ moieties, which may be the same or different, are substituted or unsubstituted monovalent hydrocarbon groups of 1 to 10 carbon atoms or amino to group-containing organic groups of 1 to 10 carbon atoms. At least one R⁸ moiety, and preferably from 2 to 200, includes an amino group-containing organic group. Examples of monovalent hydrocarbon groups include alkyl groups such as methyl, ethyl, propyl and butyl groups, cycloalkyl groups such as the cyclohexyl group, and aryl groups such as the phenyl group. In addition, some or all of the hydrogen atoms bonded to carbon atoms on these groups may be substituted with halogen atoms or other groups. Exemplary substituents include tritluromethyl and 3,3,3-trifluoropropyl groups. Of these, a saturated aliphatic group or an aromatic group is preferred, with method and phenyl groups being more preferred.

The amino group in the amino group-containing organic group is preferably a primary amine. The amino group-containing organic group is preferably, for example, an aminoalkyl group of 1 to 10 carbon atoms which may have an intervening ether group or thioether group, with an aminopropyl group being especially preferred. Specific amino group-containing organic group structures are shown below, but the amino group-containing organic group is not limited to these.

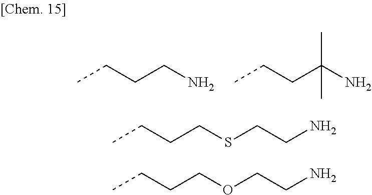

In the formulas, a dashed line indicates a site available for bonding.

The amine equivalent weight of component (A) is preferably from 200 to 5,000 g/mol, more preferably from 300 to 4,800 g/mol, and even more preferably from 400 to 4,500 g/mol. When the equivalent weight is lower than 200 g/mol, the heat resistance may decline due to the lower molecular weight of the product. When higher than 5,000 g/mol, the heat resistance may decline due to the smaller number of functional groups introduced.

In formula (4), the subscript e is an integer which is 2 or more, and preferably from 2 to 12; the subscript f is an integer which is 0 or more, preferably from 1 to 998, more preferably from 5 to 998, and even more preferably from 5 to 500; the subscript g is an integer which is 0 or more, and preferably from 0 to 10; and the subscript h is an integer which is 0 or more, and preferably from 0 to 5. Also, 2>e+f+g+h≤1,000, and preferably 7≤e+f+g+h≤527. When the sum e+f+g+h is larger than 1,000, the viscosity may become to high and the workability may worsen.

The specific structure of component (A) is exemplified by, but not limited to, those of the following formulas. In the formulas below, “Me” and “Ph” respectively stand for methyl and phenyl groups. Also. “A” stands for an aminopropyl group, although this may be any amino group-containing organic group of 1 to 10 carbon atoms.

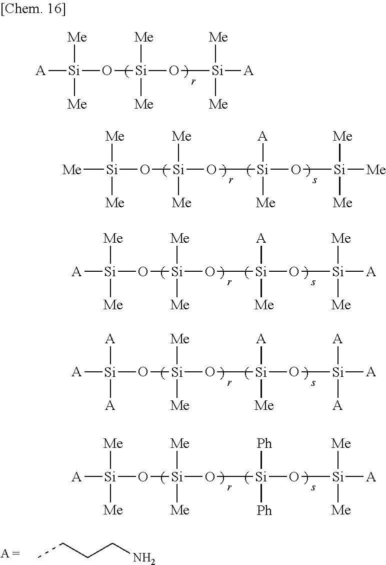

Here, r>0, s≥1, and the dashed line indicates a site available for bonding.

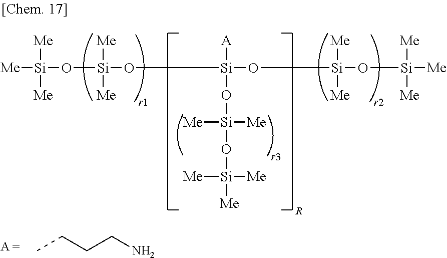

Here, r1>0, r2≥0, r3≥0, R≥1. and the dashed line indicates a site available for bonding.

### [Component (B)]

Component (B) is an organic compound of general formula (5) or (6) below

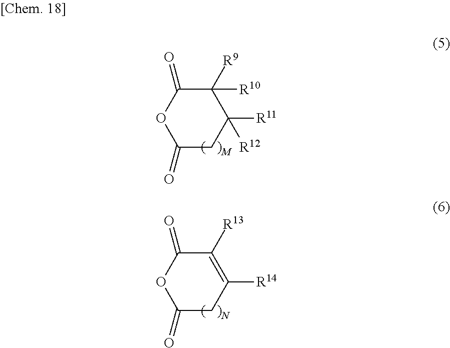

(wherein R⁹ to R¹⁴, which may be mutually the same or different, are hydrogen atoms or to substituted or unsubstituted monovalent hydrocarbon groups of 1 to 10 carbon atoms, and R⁹ or R¹⁰ and R¹¹ or R¹², or R¹³ and R¹⁴, may bond together to form a ring; and M and N are integers from to 3).

In above formulas (5) and (6), R⁹ to R¹⁴, which may be mutually the same or different, are hydrogen atoms or substituted or unsubstituted monovalent hydrocarbon groups of 1 to 10 carbon atoms. Examples of monovalent hydrogen groups include alkyl groups such as methyl, ethyl, propyl and butyl groups, cycloalkyl groups such as the cyclohexyl group, and aryl groups such as the phenyl group. In addition, some or all of the hydrogen atoms bonded to carbon atoms on these groups may be substituted with halogen atoms or other groups. Exemplary substituents include trifluoromethyl and 3,3,3-trifluoropropyl groups. Hydrogen atoms and methyl groups are preferred.

R⁹ or R¹⁰ and R¹¹ or R¹², or R¹³ and R¹⁴, may bond together to form a ring. Examples of the ring include cyclopropane, cyclobutane, cyclopentane, cyclohexane and benzene rings. A benzene ring is preferred.

M and N are each integers from 0 to 3, preferably integers from 0 to 2, and more preferably 0 or 1.

Specific structures of component (B) are shown below, but are not limited to these.

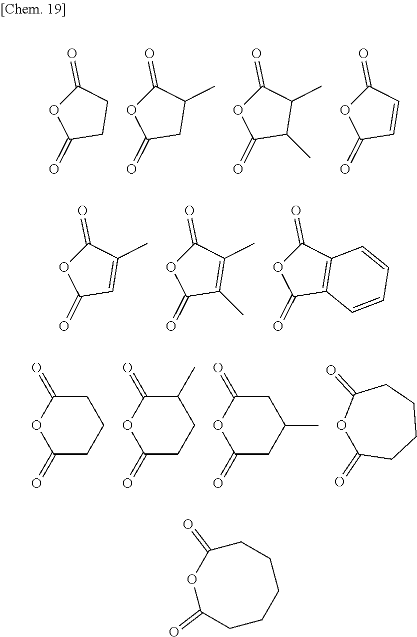

Component (B) is preferably succinic anhydride, maleic anhydride, glutaric anhydride, adipic anhydride, pimelic anhydride or phthalic anhydride, and more preferably succinic anhydride or maleic anhydride.

Component f B) is used in an amount corresponding to a molar ratio of from 1 to 3, preferably from 1 to 2.5, and more preferably from I to 2, with respect to the amino groups in component (A). At a molar ratio lower than 1, unreacted amino groups remain, which may worsen the heat resistance or may, when rendered into the subsequently described composition, give rise to poor curing. At a molar ratio higher than 3, the efficiency may worsen due to the removal of unreacted component (B) during purification.

### [Component (C)]

Component (C) is a Lewis acid catalyst. Various types of Lewis acids can be mentioned as examples, including boron compounds, aluminum compounds, scandium compounds, titanium compounds, vanadium compounds, iron compounds, cobalt compounds, nickel compounds, copper compounds, zinc compounds, lanthanum compounds and cerium compounds. A metal compound is preferred, with a zinc compound being especially preferred.

Zinc compounds that may be suitably used include the following inorganic zinc compounds: halogenated zinc compounds such as zinc chloride, zinc bromide and zinc iodide; and zinc salts such as zinc nitrate, zinc sulfate, zinc carbonate and zinc trifluoromethanesulfonate. Zinc chloride and zinc bromide are preferred.

Component (C) is used in an amount corresponding to a molar ratio of from 0.1 to 2, preferably from 0.2 to 1.8, and more preferably from 0.5 to 1.5, with respect to the amino groups in component (A). At a molar ratio lower than 0.1, the reaction slows and a long time may be required. On the other hand, at a molar ratio higher than 2, the efficiency may worsen due to removal of component (C) from the reaction system.

[Component (D)]

Component (D) is a silylating agent. Exemplary silylating agents include chlorosilane compounds and disilazane compounds. A disilazane compound is preferred.

Examples of disilazane compounds include hexamethyldisilazane, 1,1,3,3-tetramethyldisilazane, 1,3-divinyl-1,1,3,3-tetramethyl disilazane and 1,3-diphenyl-1,1,3,3-tetramethyldisilazane. Hexamethyldisilazane is preferred.

Component (D) is used in an amount corresponding to a molar ratio of from 1 to 3, preferably from 1.1 to 2.8, and more preferably from 1.2 to 2.5, with respect to the amino groups in component (A). At a molar ratio lower than 1, the reaction may not fully proceed. On the other hand, at a molar ratio higher than 3, the efficiency may worsen due to removal of component (D) from the reaction system.

### [Component (E)]

Component (E) is an organic solvent, this being a reaction solvent for dissolving the substrate (components (A) and (B)). Examples of component (E) include aromatic hydrocarbon solvents such as toluene and xylene; aliphatic hydrocarbon solvents such as hexane, heptane, octane_{;} isooctane, decane, cyclohexarie, methylcyclohexane and isoparaffin; hydrocarbon solvents such as industrial gasoline, petroleum benzin and solvent naphtha; ketone solvents such as acetone, methyl ethyl ketone, 2-pentanone, 3-pentanone, 2-hexanone, 2-heptanone, 4-heptanone, methyl isobutyl ketone, diisobutyl ketone, acetonylacetone and to cyclohexanone; ester solvents such as ethyl acetate, propyl acetate, isopropyl acetate, butyl acetate and isobutyl acetate; ether solvents such as diethyl ether, dipropyl ether, diisopropyl ether, dibutvl ether, 1,2-dimethoxyethane and 1,4-dioxane; esters such as 2-methoxyethyl acetate, 2-ethoxyethyl acetate, propylene glycol monomethyl ether acetate and 2-butoxyethyl acetate; solvents having an ether moiety, and mixed solvents of the above. These may be used singly or two or more may be suitably combined and used together.

Component (E) is preferably a solvent which dissolves component (A) and component (D), but does not dissolve component (C). This is to enable component (C) to be easily removed following reaction completion. That is, in cases where component (C) does not dissolve, it can be removed by filtration; by contrast, in cases where component (C) dissolves, a cleaning operation is needed, resulting in a poor efficiency and yield. Component (13) may or may not dissolve in component (E). However, the reaction proceeds more rapidly when it dissolves, and so it is preferable for component (B) to dissolve in component (E).

The amount of component (E) included per 100 parts by weight of component (A) is from 0 to 5,000 parts by weight, preferably from 0 to 4,000 parts by weight, and more preferably from 0 to 3,000 parts by weight. When more than 5,000 parts by weight is included, the reaction may proceed more slowly. When component (E) is included, the content thereof is preferably set to at least 200 parts by weight, and especially at least 500 parts by weight.

The organopolysiloxane of above average compositional formula (1) is prepared using above components (A) to (E).

### [Addition Reaction of Components (A) and (B)]

Components (A) and (B) are the reaction substrate. More specifically, component (A) is the base resin and component (B) is the reactant. When components (A) and (B) are mixed together in the presence of, optionally, component (E), they react exothermally even at room temperature (25° C.) to form an organopolysiloxane (F) of the average composition formula (7) below.

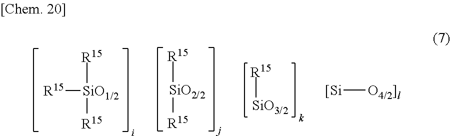

In this formula, the R¹⁵ moieties, which may be the same or different, are substituted or unsubstituted monovalent hydrocarbon groups of 1 to 10 carbon atoms or organic groups having a structure of general formula (8) or (9) below, at least one R¹⁵ moiety including an organic group having a structure of general formula (8) or (9) below; and the subscript i is an integer of 2 or more, the subscript j is an integer of 0 or more, the subscript k is an integer of 0 or more, the subscript I is an integer of 0 or more, and 2≤i+j+k+l≤1,000).

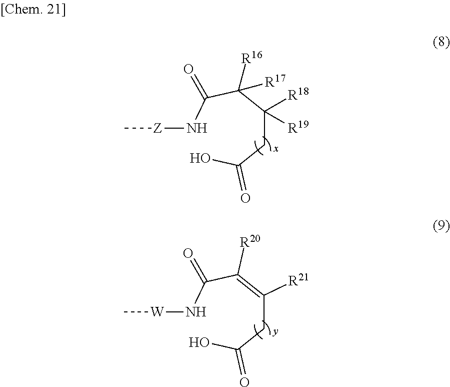

Here, R¹⁶ to R²¹, which may be mutually the same or different, are hydrogen atoms or substituted or unsubstituted monovalent hydrocarbon groups of 1 to 10 carbon atoms, and R¹⁶ or R¹⁷ and R¹⁸ or R¹⁹, or R²⁰ and R²¹, may bond together to form a ring; the subscripts x and y are integers from 0 to 3; Z and W are substituted or unsubstituted divalent hydrocarbon groups of 1 to 10 carbon atoms which may have an intervening heteroatom; and the dashed line represents a site available for bonding.

In above formula (7), the R¹⁵ moieties, which may be the same or different, are substituted or unsubstituted monovalent hydrocarbon groups of 1 to 10 carbon atoms or organic groups having a structure of general formula (8) or (9) above, at least one R¹⁵ moiety including an organic group having a structure of general formula (8) or (9) above. Exemplary monovalent hydrocarbon groups include alkyl groups such as methyl, ethyl, propyl and butyl groups, cycloalkyl groups such as the cyclohexyl group, and aryl groups such as the phenyl group. In addition, some or all of the hydrogen atoms bonded to carbon atoms on these groups may be substituted with halogen atoms or other groups. Exemplary substituents include trifluoromethyl and 3,3,3-trifluoropropyl groups. Of these, a saturated aliphatic group or an aromatic group is preferred, with a methyl group or phenyl group being more preferred.

At least one, preferably from 2 to 200, and more preferably from 2 to 150 R¹⁵ moieties are organic groups having a. structure of general formula (8) or (9).

In formulas (8) and (9), R¹⁶ to R²¹, which may be mutually the same or different, are hydrogen atoms or substituted or unsubstituted monovalent hydrocarbon groups of 1 to 10 carbon atoms. Exemplary monovalent hydrocarbon groups include alkyls groups such as methyl, ethyl, propyl and butyl groups, cycloalkyl groups such as the cyclohexyl group, and aryl groups such as the phenyl group. In addition, some or all hydrogen atoms bonded to carbon atoms on these groups may be substituted with halogen atoms or other groups. Exemplary substituents include trifluoromethyl and 3,3,3-trifluoropropyl groups, with hydrogen atoms and methyl groups being preferred.

R¹⁰ or R¹⁷ and R¹⁸ or R¹⁹, or R²⁰ and R²¹, may bond together to form a ring. Examples of such rings include cyclopropane, cyclobutane, cyclopentane, cyclohexane and benzene rings, with a benzene ring being preferred.

The subscripts x and y are integers from 0 to 3, preferably from 0 to 2, and more preferably 0 or 1.

Z and W are substituted or unsubstituted divalent hydrocarbon groups of 1 to 10 carbon atoms which may have an intervening heteroatom. Examples include alkylene groups such as CH₂, C₂H₄, C₃H₆, C₄H₈, C₅H₁₀ and C₆H₁₂ which may have an intervening ether group or thioether group. Alternatively, a cyclic structure such as a phenylene or cyclohexylene group may be formed, and some or all of the hydrogen atoms bonded to carbon atoms may be substituted with halogen atoms or other groups.

Exemplary structures of general formulas (8) and (9) include, but are not limited to, to those shown below.

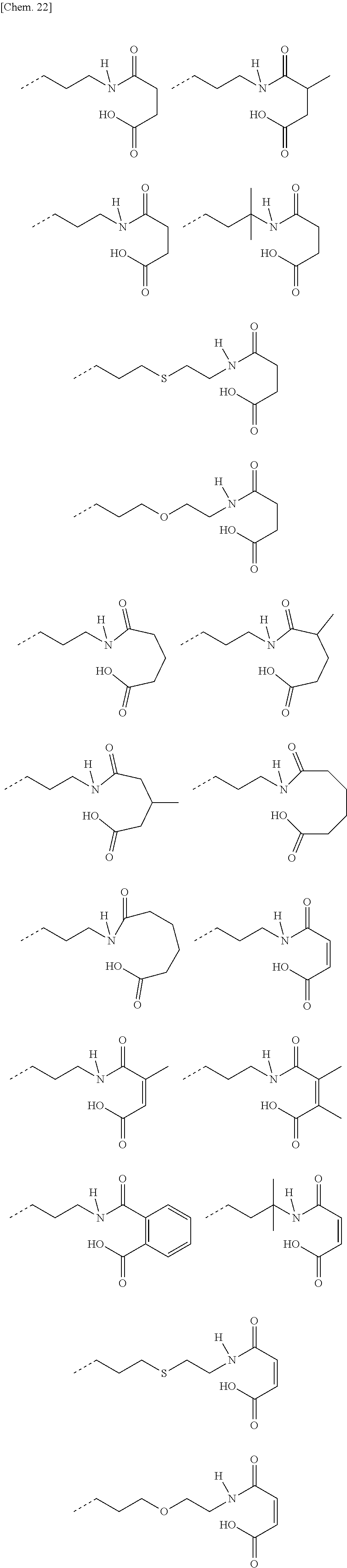

In the formulas, the dashed line indicates a site available for bonding.

In above formula (7), the subscript i is an integer of 2 or more, and preferably from 2 to 12; the subscript j is an integer of 0 or more, preferably from 1 to 998, more preferably from 5 to 998, and even more preferably from 5 to 500; the subscript k is an integer of 0 or more, and preferably from 0 to 10; the integer 1 is an integer of 0 or more, and preferably from 0 to 5; and 2≤i+j+k+l≤1,000, and preferably 7≤i+j+k+l≤527. When the sum i+j+k+l is larger than 1,000, the viscosity may be high and the workability may worsen.

Exemplary structures of component (F) include, but are not limited to, those of the to formulas shown below. In the following formulas, “Me” and “Ph” stand for, respectively, a methyl group and a phenyl group. Also, “B” is represented by the structures shown below, although any organic group having the structure in formula (8) or (9) is acceptable.

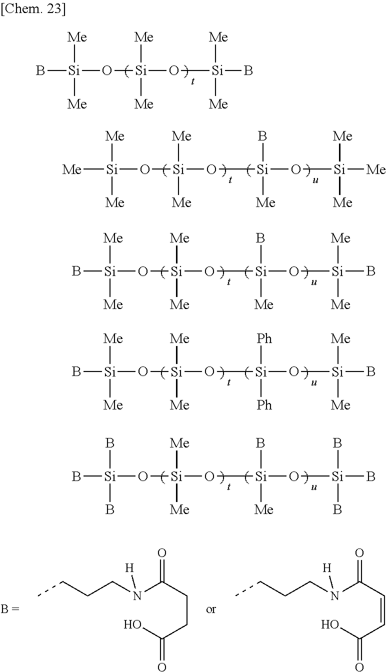

Here, t≥0, u≥>1, and a dashed line indicates a site available for bonding.

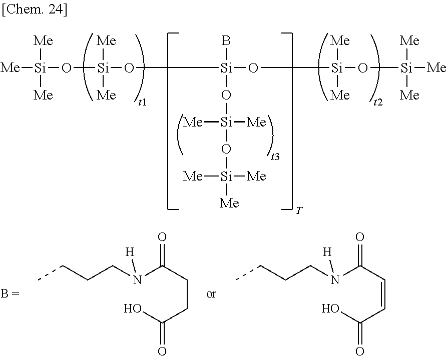

Here, t1≥0, t2≥0, t3≥0, T≥1, and a dashed line indicates a site available for bonding.

### [Catalytic Imidization Reaction]

When a condensation reaction between the amide groups and carboxyl groups in component (F) arises, the target organopolysiloxane of average compositional formula (1) can be obtained. However, having the reaction proceed by heating alone is difficult; a reaction temperature of about 200° C. or even more is required, which is energetically to disadvantageous. It is for this reason that above components (C) and (D) are needed.

Ring closure and imidization by a condensation reaction is required in order to obtain an organopolysiloxane of average composition formula (1) from component (F). Components (C) and (D) are used for this purpose.

Component (C) is a catalyst, and component (D) is a reagent for silyl capping carboxyl groups in component (F). When components (F) and (C) are mixed together and component (D) is added thereto, the carboxyl groups in component (F) are silylated. With the application of heat, the silylated carboxyl groups and the amide groups condense, enabling an organopolysiloxane of formula (1) to be obtained. Condensation does not readily arise with carboxyl groups, but silylation of these groups makes it easier for condensation to proceed. It is thought that reacting component (C) with component (D) plays two roles at this time; namely, that of forming an active species for silylation and, although the detailed mechanism is not clear, that of catalyzing the condensation reaction.

### [Purification of Product]

Following the completion of imidization, because the ammonia generated from component (D) is present within the system, it must be removed. The method for removing ammonia is not particularly limited, although one exemplary method for doing so involves neutralizing the ammonia by reacting it with an acidic substance, and filtering off the resulting salt. Examples of the acidic substance include hydrochloric acid, sulfuric acid, nitric acid, phosphoric acid, boric acid, formic acid, acetic acid, citric acid, lactic acid and butyric acid. From the standpoint of the reactivity, the acidic substance is preferably a to liquid. Acetic acid and phosphoric acid are preferred.

If Component (C) is insoluble in component (E), it can be removed by filtration. When it is dissolved within component (E), it must be washed and eliminated from the system by liquid-liquid extraction.

Unreacted component (B) and components (D) and (E) can be removed by vacuum distillation.

The target organopolysiloxane of the invention can be prepared by the foregoing steps.

The organopolysiloxane of the invention has an excellent heat resistance and can be suitably used in various applications, including oils such as industrial heat transfer media and lubricants, heat-resistant coating materials, heat-resistant rubber materials, and additives for resins.

[Curable Composition that Uses an Organopolysiloxane]

The curable composition of the invention is characterized by including an organopolysiloxane of the above average compositional formula (1). In particular, it is preferably one wherein the R¹ moieties in formula (1), which may be the same or different, are substituted or unsubstituted monovalent hydrocarbon groups of 1 to 10 carbon atoms or organic groups having a structure of general formula (3′) below, at least one R¹ moiety including an organic group having a structure of general formula (3′) below.

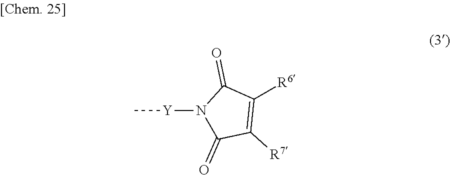

Here, R^{6′} and R^{7′}, which may be mutually the same or different, are hydrogen atoms or substituted or unsubstituted monovalent hydrocarbon groups of 1 to 5 carbon atoms, Y is as defined above, and the dashed line represents a site available for bonding.

In formula (3′), R^{6′} and R^{7′}, which may be mutually the same or different, are hydrogen atoms or substituted or unsubstituted monovalent hydrocarbon groups of 1 to 5 carbon atoms. Exemplary monovalent hydrocarbon groups include alkyl groups such as to methyl, ethyl, propyl and butyl groups. In addition, some or all of the hydrogen atoms bonded to carbon atoms on these groups may be substituted. Examples of the substituents include trifluromethyl and 3,3,3-trilluoropropyl groups. R^{6′} and R^{7′} are preferably hydrogen atoms or methyl groups, with hydrogen atoms being especially preferred.

Specific structures of general formula (3′) are shown below, but are not limited to these.

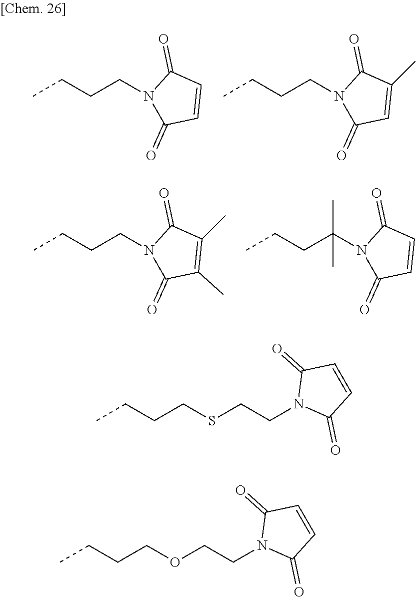

Here, a dashed line indicates a site available for bonding.

In formula (1), the organopolysiloxane that includes as the R¹ moiety an organic group of formula (3′) has a structure which is exemplified by, but not limited to, those of the following formulas. in the formulas below, “Me” and “Ph” stand for, respectively, a methyl group and a phenyl group. Also. “I” stands for a N-maleimidopropyl group, although this may be any organic group having a structure of formula (3′).

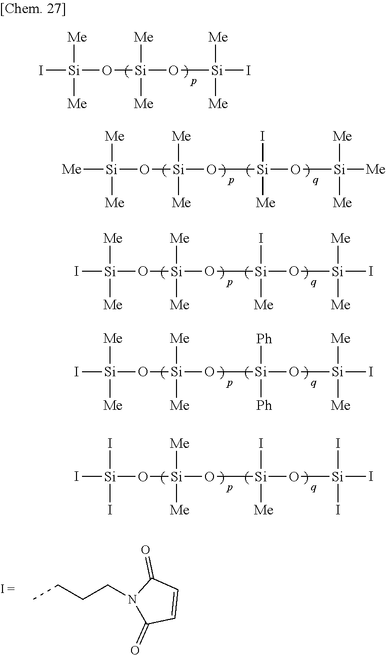

Here, p≥0, q≥1, and the dashed line indicates a site available for bonding.

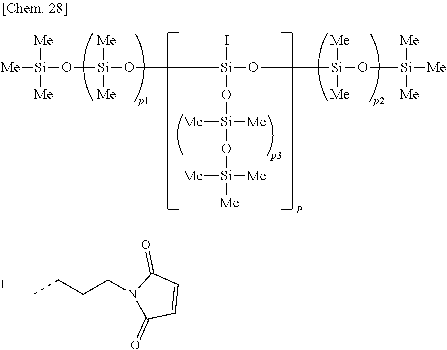

Here, p1≥0, p2≥0, p3≥0, P≥1, and the dashed line indicates a site available for bonding.

The organic groups (functional groups) of the structure represented by formula (3′) above are thought to give rise to two reactions when exposed to light; namely, radical polymerization at carbon-carbon double bond sites and dimerization. It is possible to form the cured product of the invention by way of these reactions. Moreover, neither reaction requires a photopolymerization initiator.

The curable composition of the invention includes the organopolysiloxane of formula (1) above. This curable composition may consist solely of the organopolysiloxane of formula (1), although other additives may be included within a range that does not detract from the objects of the invention. Specific examples of such additives include photopolymerization initiators, antioxidants, reactive diluents, leveling agents, fillers, antistatic agents, defoamers and pigments.

Because the organopolysiloxane of formula (1) can be cured by exposure to light, it is possible to use the curable composition of the invention without including a photoinitiator.

The curable composition of the invention can be cured by exposure to light, and especially exposure to radiation. Energy rays in the ultraviolet to visible light region (from about 100 nm to about 800 nm) obtained from, preferably, high-pressure or ultrahigh-pressure mercury vapor lamps, metal halide lamps, xenon lamps, carbon arc lamps, fluorescent lamps, semiconductor solid state lasers, argon lasers, He—Cd lasers, Krf excimer lasers, ArF excimer lasers, F₂ lasers and the like can be advantageously used as the radiation. A radiation light source having a high brightness at 200 to 400 nm is preferred. In addition, high-energy radiation such as electron beams or x-rays can also be used. With regard to the radiation energy exposure temperature and time, exposure for a period of from about 0.1 second to about 10 seconds at standard temperature (25° C.) suffices, although in cases where the energy ray transmittivity is low or the film thickness of the curable composition is large, it may be preferably to carry out exposure for a longer period of time. Where necessary, following exposure to the energy rays, a postcure that entails heating at from room temperature to (25° C.) to 150° C. for a period of from several seconds to several hours is also possible.

The curable composition of the invention can be suitably used in coating materials, rubber materials and the like. Examples of products which use the cured form of this composition include parting films, pressure-sensitive adhesive films, adhesives, encapsulants, rubber rollers, heat-dissipating sheets and sealants.

### EXAMPLES

The invention is illustrated more fully below by way of Examples and Comparative Examples. However, the invention is not limited by these Examples. In the Examples below, “Me” stands for a methyl group.

### Example 1

A 300 mL three-neck flask fitted with a stirrer, a thermometer, a dropping funnel and a reflux condenser was charged with 3.20 g (0.032 mol) of succinic anhydride as component (B) and 81.74 g (70 wt %) of toluene as component (E). These ingredients were mixed and stirred at room temperature (25° C.), during which time 13.76 g (0.032 mol in terms of amino groups) of the organopolysiloxane of formula (A-1) below that had been charged into the dropping funnel as component (A) was added dropwise thereto. Following the completion of dropwise addition, the flask contents were stirred 4 hours at room temperature (25° C.), the flask was charged with 7.20 g (0.032 mol) of zinc bromide as component (C), and the system was heated to 50° C. To this was added dropwise, as component (D), 7,76 g (0.048 mol) of hexamethyldisilazane that had been charged into a dropping funnel. Following the completion of dropwise addition, the system was aged for one hour at 80° C. and then allowed to cool to 40° C. or below, at which point 3.17 g (0.053 mol) of acetic acid was added dropwise and the system was further aged for 30 minutes. Solids within the reaction solution were removed by filtration, and vacuum distillation was carried out at 70° C. for one hour, followed by additional vacuum distillation at 120° C. for one hour, thereby giving a clear yellow liquid. As a result of analysis, this was confirmed to be an organopolysiloxane of formula (I) below.

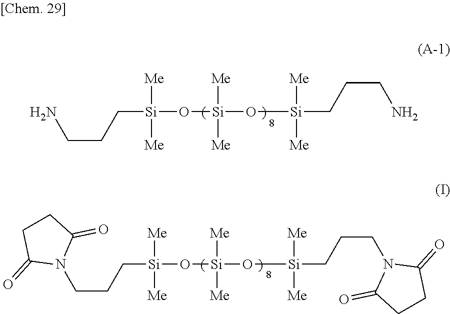

### Example 2

Aside from using 3.14 g (0.032 mol) of maleic anhydride instead of succinic anhydride as component (B), preparation was carried out in the same way as in Example 1, giving a clear yellow liquid. As a result of analysis, this was confirmed to be an organopolysiloxane of formula (11) below.

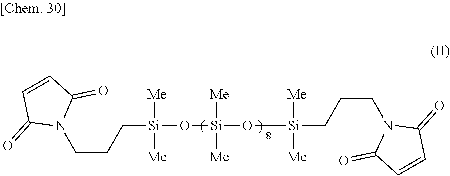

### Example 3

Aside from using 3.65 g (0.032 mol) of glutaric anhydride instead of succinic anhydride as component (B). preparation was carried out in the same way as in Example 1, giving a black liquid. As a result of analysis, this was confirmed to be an organopolysiloxane of formula (III) below.

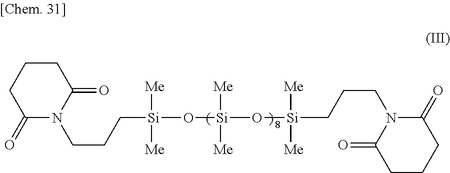

### Example 4

Aside from using 4.74 g (0.032 mol) of phthalic anhydride instead of succinic anhydride as component (B), preparation was carried out in the same way as in Example 1, giving a clear yellow liquid. As a result of analysis, this was confirmed to be an organopolysiloxane of formula (IV) below.

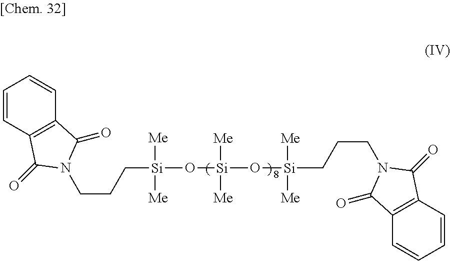

### Example 5

Aside from using 13.33 g (0.032 mol) of the organopolysiloxane of formula (A-2) below instead of the organopolysiloxane of formula (A-1) as component (A), preparation was carried out in the same way as in Example 2, giving a clear yellow liquid. As a result of analysis, this was confirmed to be an organopolysiloxane of formula (V) below.

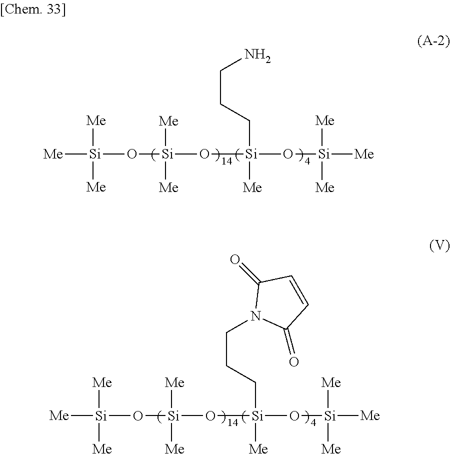

### <Heat Resistance>

The heat resistance of the organopolysiloxanes of Examples 1 to 4 obtained as described above were evaluated by thermogravimetric analysis. Specifically, 10 mg of sample was placed in the apparatus, heated in air from room temperature (25° C.) to 400° C. at a temperature rise rate of 10° C./min, and the temperature at which the weight loss ratio became 5% was measured. The measurement apparatus used was the Thermo plus TG8120 (from Rigaku Corporation). As Comparative Example 1, the heat resistance of the organopolysiloxane of above formula (A-1) was evaluated. These results are shown presented in Table 1.

TABLE 1

| | | | | | Comparative |
|---|---|---|---|---|---|
| | Example 1 | Example 2 | Example 3 | Example 4 | Example 1 |
| Sample (formula) | (I) | (II) | (III) | (IV) | (A-1) |
| Modifying | succinimide | maleimide | glutarimide | phthalimide | amino |
| functional group | | | | | |
| 5% Weight loss | 282 | 288 | 281 | 288 | 175 |
| temperature (° C.) | | | | | |

The results in Table 1 demonstrate that the organopolysiloxanes of the invention have temperatures at the same loss of weight that are higher than those of the amino-modified polysiloxanes serving as the starting material, and thus have a better heat resistance.

### Example 6

The coating film obtained by coating the organopolysiloxane prepared in Example 2 in an amount of about 0.6 g/m² onto polyethylene (PE) laminated paper was exposed to ultraviolet light using two 80 W/cm² high-pressure mercury vapor lamps, and was then evaluated by the following method to determine whether it had cured.

### <Curability>

The curability of the organopolysiloxane was evaluated using a UV irradiation system. That is, the coating film obtained by applying the organopolysiloxane onto PE laminated paper in an amount of about 0.6 g/m² was irradiated, using two 80 W/cm² high-pressure mercury vapor lamps, with ultraviolet light in a dose of from 200 to 500 mJ/cm² at a temperature of 25° C. The condition of the film following exposure was evaluated according to the following criteria. The results are presented in Table 2,

O: Film is cured and, when touched by finger, resin does not stick to finger

X: When film is touched by finger, uncured resin sticks

### Example 7

Aside from using the organopolysiloxane prepared in Example 5, the same procedure was carried out as in Example 6.

### Comparative Example 2

Aside from using the organopolysiloxane of formula (VI) below, the same procedure was carried out as in Example 6.

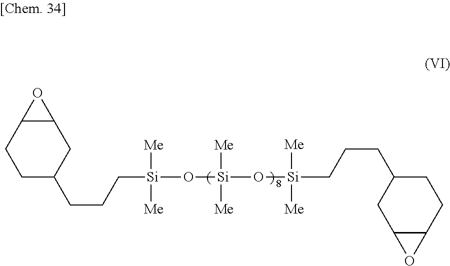

### Comparative Example 3

Aside from using the organopolysiloxane of formula (VII) below, the same procedure was carried out as in Example 6.

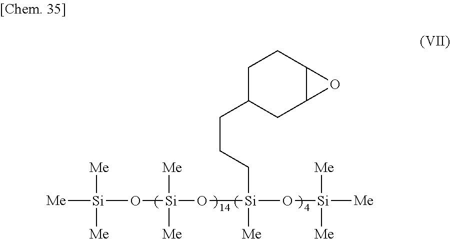

### Comparative Example 4

Aside from using the organopolysiloxane of formula (VIII) below, the same procedure was carried out as in Example 6.

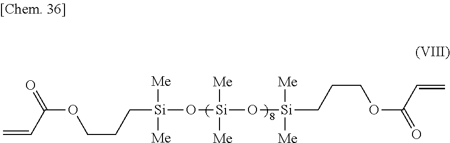

### Comparative Example 5

Aside from using the organopolysiloxane of formula (IX) below, the same procedure was carried out as in Example 6.

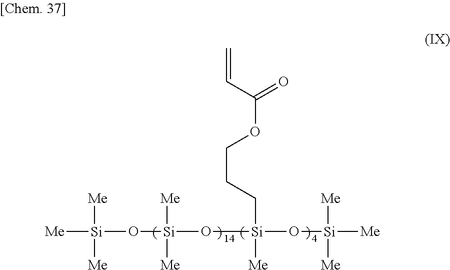

### Comparative Example 6

Aside from using a mixture of the organopolysiloxane of formula (X) below and the organopolysiloxane of formula (XI) below in the weight ratio (X)/(XI)=59.2/40.8 (the mercapto groups included in (XI) having a molar ratio of 2.0 with respect to the vinyl groups included in (X)), the same procedure was carried out as in Example 6.

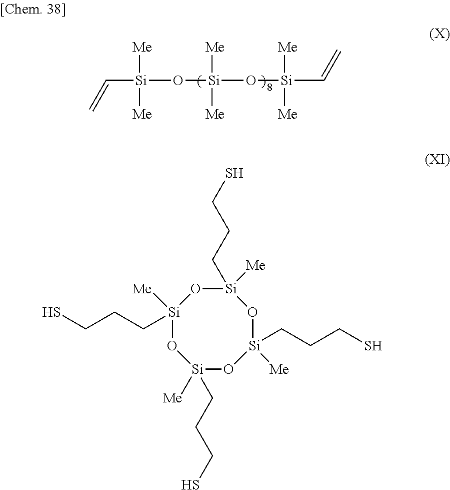

### Comparative Example 7

Aside from using a mixture of the organopolysiloxane of formula (XII) below and the organopolysiloxane of formula (XI) above in the weight ratio (XII)/(XI)=59.0/41 (the mercapto groups included in (XI) having a molar ratio of 2.0 with respect to the vinyl groups included in (MI)), the same procedure was carried out as in Example 6.

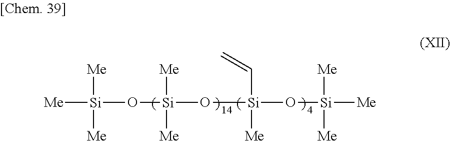

TABLE 2

| | | | | Comparative | Comparative | Comparative | Comparative | Comparative | Comparative |
|---|---|---|---|---|---|---|---|---|---|
| | | Example 6 | Example 7 | Example 2 | Example 3 | Example 4 | Example 5 | Example 6 | Example 7 |
| Organopolysiloxane | | (II) | (V) | (VI) | (VII) | (VIII) | (IX) | (X)/(XI) | (XII)/(XI) |
| (formula) | | | | | | | | | |
| Modifying | | maleimide | maleimide | epoxy | epoxy | acrylic | acrylic | vinyl/ | vinyl/ |
| functional group | | | | | | | | mercapto | mercapto |
| Curability | 200 mJ/cm² | X | ◯ | X | X | X | X | X | X |
| | 300 mJ/cm² | ◯ | ◯ | X | X | X | X | X | X |
| | 400 mJ/cm² | ◯ | ◯ | X | X | X | X | X | X |
| | 500 mJ/cm² | ◯ | ◯ | X | X | X | X | X | X |

The results in Table 2 show that, for the organopolysiloxanes of the invention, even without the addition of a photoinitiator, the coating films could be cured by exposure to ultraviolet light. Accordingly, they show promise for use in one-part photocurable compositions that do not require a photoinitiator.

1-14. (canceled)

15. An organopolysiloxane which has average compositional fommla (1) below and includes at least one organic: group with a structure of general formula (2) or (3) below per molecule 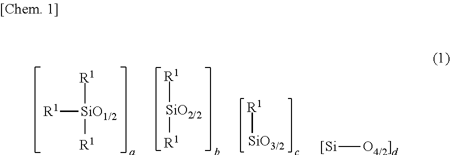
(wherein the R¹ moieties, which may be the same or different, are substituted or unsubstituted monovalent hydrocarbon groups of 1 to 10 carbon atoms or organic groups having a structure of general formula (2) or (3) below, at least one R¹ moiety including an organic group having a structure of general formula (2) or (3) below; and the subscript a is an integer of 2 or more, the subscript b is an integer of 0 or more, the subscript c is an integer of 0 or more, the subscript d is an integer of 0 or more, and 2≤a+b+c+d≤1,000) 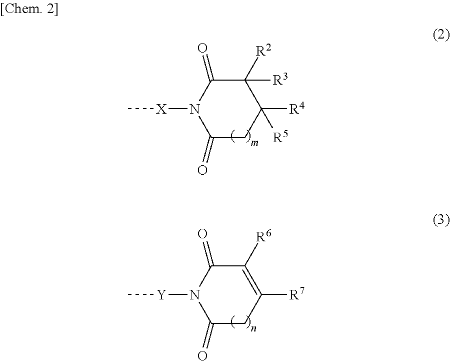
(wherein R² to R⁷, which may be mutually the same or different, are hydrogen atoms or substituted or unsubstituted monovalent hydrocarbon groups of 1 to 10 carbon atoms, and R² or R³ and R⁴ or R⁵, or R⁶ and R⁷, may bond together to fun a ring; the subscripts m and n are integers from 0 to 3; X and Y are substituted or unsubstituted divalent hydrocarbon groups of 1 to 10 carbon atoms which may have an intervening heteroatom; and the dashed line represents a site available for bonding),

16. The organopolysiloxane of claim 15 wherein, in formula (1), the subscript a is an integer from 2 to 12, the subscript b is an integer from 5 to 500, the subscript c is an integer from 0 to 10, the subscript d is an integer from 0 to 5, and the sum a+b+c+d is from 7 to 527.

7. A method for preparing the organopolysiloxane hay formula (1) of claim 15 using:
(A) 100 parts by weight of an organopolysiloxane which has average compositional fonnula (4) below and includes at least one amino group-containing organic group of 1 to 10 carbon atoms per molecule 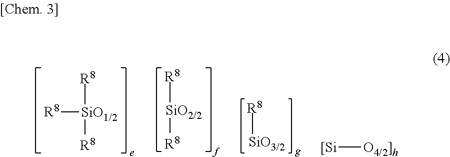
(wherein the R⁸ moieties, which may be the same or different, are substituted or unsubstituted monovalent hydrocarbon groups of 1 to 10 carbon atoms or amino group-containing organic groups of 1 to 10 carbon atoms, at least one R⁸ moiety including an amino group-containing organic group of 1 to 10 carbon atoms; and the subscript e is an integer of 2 or more, the subscript f is an integer of 0 or more, the subscript g is an integer of 0 or more, the subscript h is an integer of 0 or more, and 2≤e+f+g+h≤1,000),
(B) an organic compound of general fomiula (5) or (6) below in an amount corresponding to a molar ratio of from 1 to 3 with respect to the amino groups in component (A) 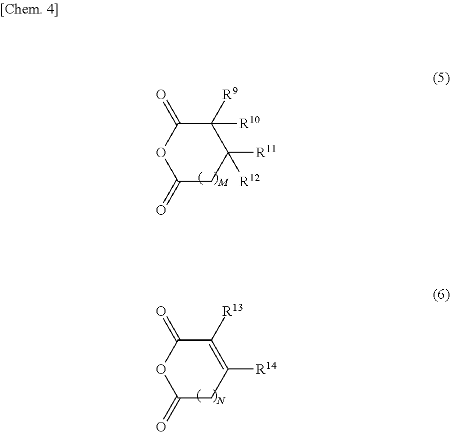
(wherein R⁹ to R¹⁴, which may be mutually the same or different, are hydrogen atoms or substituted or unsubstituted monovalent hydrocarbon groups of 1 to 10 carbon atoms, and R⁹ or R¹⁰ and R¹¹ or R¹², or R¹³ and R¹⁴, may bond together to form a ring; and M and N are integers from 0 to 3),
(C) a Lewis acid catalyst in an amount corresponding to a molar ratio of from 0 to 2 with respect to the amino groups in component (A),
(D) a silylating agent in an amount corresponding to a molar ratio of from 1 to 3 with respect to the amino groups in component (A), and
(E) an organic solvent in an amount of from 0 to 5,000 parts by weight per 100 parts by weight of component (A),
which method comprises the steps of:
reacting component (A) with component (B) in the presence of, optionally, component (E) to form an organopolysiloxane (F) of average compositional formula (7) below 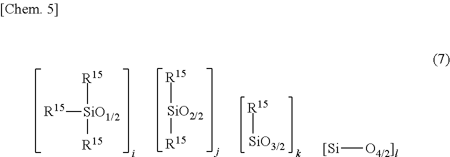
(wherein the R¹⁵ moieties, which may be the same or different, are substituted or unsubstituted monovalent hydrocarbon groups of 1 to 10 carbon atoms or organic groups having a structure of general formula (8) or (9) below, at least one R¹⁵ moiety including an organic group having a structure of general formula (8) or (9) below; and the subscript i is an integer of 2 or more, the subscript j is an integer of 0 or more, the subscript k is an integer of 0 or more, the subscript 1 is an integer of 0 or more, and 2≤i+j+k+l≤1,000) 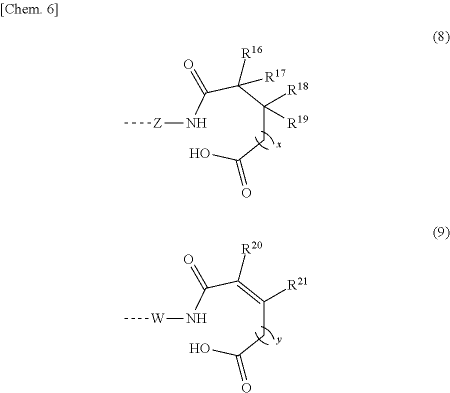
(wherein R¹⁶ to R²¹, which may be mutually the same or different, are hydrogen atoms or substituted or unsubstituted monovalent hydrocarbon groups of 1 to 10 carbon atoms, and R¹⁶ or R¹⁷ and R¹⁸ or R¹⁹, or R²⁰ and R²¹, may bond together to form a ring; the subscripts x and y are integers from 0 to 3; Z and W are substituted or unsubstituted divalent hydrocarbon groups of 1 to 10 carbon atoms which may have an intervening heteroatom; and the dashed line represents a site available for bonding); and
subsequently mixing in components (C) and (D) and effecting a condensation reaction between amide groups and carboxyl groups in component (F).

18. The organopolysiloxane preparation method of claim 17 wherein, in formula (1), the subscript a is an integer from 2 to 12, the subscript b is an integer from 5 to 500, the subscript c is an integer from 0 to 10, the subscript d is an integer from 0 to 5, and the sum a+b+c+d is from 7 to 577.

19. The organopolysiloxane preparation method of claim 17, wherein comp anent. (A) has an amine equivalent weight of from 200 to 5,000 g/mol.

20. The organopolysiloxane preparation method of claim 17, wherein component (B) is succinic anhydride, maleic anhydride, glutaric anhydiide, adipic anhydride, pimelic anhydride or phthalic anhydride.

21. The organopolysiloxane preparation method of claim 17, wherein component (C) is a metal compound.

22. The organopolysiloxane preparation method of claim 21, wherein component (C) is a zinc compound.

23. The organopolysiloxane preparation method of claim 17, wherein component (D) is a disilazane compound.

24. A curable composition which cures on exposure to radiation, comprising at least one organopolysiloxane of the average compositional formula (1′) below and including at least one organic group with a structure of general formula (3′) below per molecule 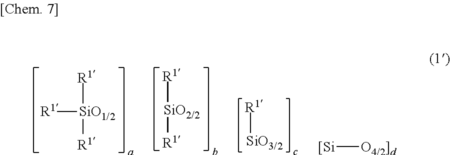
(wherein the R^{1′} moieties, which may be the same or different, are substituted or unsubstituted monovalent hydrocarbon groups of 1 to 10 carbon atoms or organic groups having a structure of general formula (3′) below, at least one le moiety including an organic group having a structure of general formula (3′) below; and the subscript a is an integer of 2 or more, the subscript b is an integer of 0 or more, the subscript c is an integer of 0 or more, the subsciipt d is an integer of 0 or more, and 2≤a+b+c+d≤1,000) 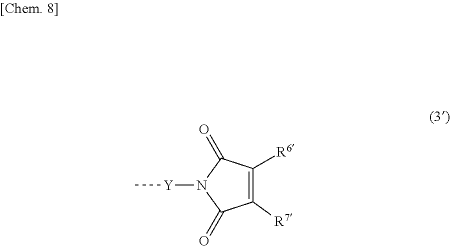
(wherein R^{6′} and R^{7′}, which may be mutually the same or different, are hydrogen atoms or substituted or unsubstituted monovalent hydrocarbon groups of 1 to 5 carbon atoms Y is as defined above; and the dashed line represents a site available for bonding).

25. The curable composition of claim 24 which comprises the organopolysiloxane of formula (1′) above.

26. The curable composition of claim 24 wherein, in formula (1′), the subscript a is an integer from 2 to 12, the subscript b is an integer from 5 to 500, the subscript c is an integer from 0 to 10, the subscript d is an integer from 0 to 5, and the sum a+b+c+d is from 7 to 527.

27. The curable composition of claim 24, wherein R^{6′} and R^{7′} of formula (3′) are hydrogen atoms.

28. The curable composition of claim 24 which includes no photopolymerization initiator.
